(19) United States
(12) Patent Application Publication
(10) Pub. No.: US 2010/0015418 A1
(43) Pub. Date: Jan. 21, 2010

(54) Facing material for a winter sports device

(75) Inventors: Helmut Holzer, St. Johann (AT); Georg Bauer, Fraham (AT)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Atomic Austria GmbH, Altenmarkt Im Pongau (AT)

(21) Appl. No.: 12/424,781

(22) Filed: Apr. 16, 2009

(30) Foreign Application Priority Data
Apr. 16, 2008 (AT) A 601/2008

(51) Int. Cl. B32B 3/10; B32B 3/26; B29C 43/00; B32B 37/24

(52) U.S. Cl. 428/196; 428/320.2; 428/195.1; 264/134; 156/242

(57) ABSTRACT

The invention relates to a method of producing a flat facing material (6) with a gliding surface (5) for a running sole of a winter sports device, whereby a base structure (7) is produced from a continuously open-pored plastic material (8) with an initial thickness (10). At least one additive (13) is introduced into the pores (9) of the base structure (7). The base structure (7) together with the additive (13) is then reduced from its initial thickness (10) by am amount within a lower limit of 20% and an upper limit of 90% in a hot pressing operation. The invention further relates to a facing material (6) produced by the method and a winter sports device with such a facing material (6).

In accordance with 35 U.S.C. §119, the applicants claim the priority of Austrian patent application No. A 601/2008 dated 16 Apr. 2008.

### BACKGROUND OF THE INVENTION

1. Field of the Invention

The invention relates to a method of producing a facing material for a running sole of a winter sports device and a winter sports device incorporating such a facing material, as defined in claims 1, 25 and 40.

2. Prior Art

Patent specification AT 371 727 B discloses a method of producing a ski runner facing of sintered plastic, whereby the plastic powder is formed to the shape of a body. Accordingly, the plastic powder is applied to a conveyor belt in the shape of a preferably endless belt, after which the powder is subjected to the effect of pressure and heat several times in alternation. Due to the multiple, alternating effect of heat and pressure, a defined porosity and hence, following the polishing process, a uniform surface structure is obtained. The desired degree of sintering and the associated porosity are easily obtained on the basis of the settings used for the pressure, temperature and dwell time and can be easily reproduced every time. The pores are used to accommodate additives subsequently.

Documents AT 332 273 B and DE 24 14 185 disclose facings for accommodating ski wax which, instead of closed surfaces, have open surfaces. Such surfaces are produced by curing a facing with a polyurethane base in the presence of increased quantities of moisture, thereby producing a structure containing bubbles. When such facings are polished, a coarse- to fine-pored facing surface is obtained. Such ski facings can also be produced by sintering fine-grained plastic particles, in which case the sintering causes a cohesive capillary structure in the facing. An open surface is obtained by appropriate grinding or cutting and polishing. Unlike a foam material with open cells, the webs between the pores are wider, thereby resulting in higher mechanical strength and good elasticity. When ski wax is applied, it can be more effectively anchored in the resultant pores and is abraded to a lesser degree when gliding on the snow.

Another known method is disclosed in document CH 579 929 A5, which involves producing blocks of sintered, preferably macromolecular, plastic powder using pressure and heat. These blocks are then cut by peeling off thin layers, which are secured to the ski running surface to form a facing. Apart from the complexity of this method and the high but unavoidable wastage of material when splitting up the blocks, another disadvantage of this method is that the pore size within the block differs. The pores of the sintered blocks close to the walls of the block are smaller than those in the interior. Another disadvantage is the fact that the facing material stretches in its longitudinal direction when the block is being cut.

Similar methods of producing webs of facing material are also known from documents AT 374 685 B and EP 0 447 356 A1. In these instances, an endless belt of the desired thickness of facing material is continuously peeled off a cylindrical sintered body.

### OBJECTIVES AND ADVANTAGES OF THE INVENTION

The underlying objective of this invention is to propose a method of producing a facing material, a facing material and a winter sports device incorporating such a facing material, which facing material has good treatment and processing properties and good gliding properties for a longer period of time.

This objective is achieved by the invention on the basis of the method defined by the characterizing features of claim 1. The surprising advantage gained by the characterizing features of claim 1 resides in the fact that at least one additive can be incorporated in the pores of the continuous, open-pored plastic material of the base structure, which already have a relatively large volume, even before the hot pressing operation, thereby enabling a higher quantity of additives to be incorporated in the base structure. The fact that the base structure incorporating the pores is produced first of all and the additive is not introduced until the hot pressing operation means that a significantly higher number of additives are available for incorporating in it. Accordingly, the process of including the additives in the base structure takes place separately from that of producing the base structure, which avoids any adverse effects which might otherwise be caused by the additives during production of the base structure. Since the additives are introduced into the pores of the base structure subsequently, it is also possible to use additives which would otherwise tend to separate out of the base structure during the production process, because they are “sucked into” the semi-finished product during the method step of filling the pores. This also means that significantly higher concentrations of additives can be incorporated in the pores of the base structure than has been the case with the methods of manufacturing facing materials known to date. The process of incorporating the additives in the pores of the base structure will then depend on the respective aggregate state of the additives, and the volume of the individual pores prior to the hot pressing operation is of a big enough size to accommodate a high quantity of additives. Due to the hot pressing operation which takes place after incorporating additives in the pores, a highly compacted gliding surface is obtained, in which the lubricant is incorporated throughout the entire facing material based on a form of supply chambers. Processing and storage is also made easier as a result because a standard base structure of the open-pored plastic material can be produced and the additive or additives is or are incorporated in the pores depending on what winter sports devices have to be produced. A semi-finished product is produced by a hot pressing operation and can then be sent for further processing to produce the winter sports device. The hot pressing operation can also be conducted at a lower pressure and at a lower temperature than has been possible with comparable sintering methods in the past.

Also of advantage is a method based on the characterizing features defined in claim 2 because it enables account to be taken of a range of different conditions of usage and the quantity of additives available for inclusion in the facing material can be easily varied.

Also of advantage is a variant of the method defined in claim 3, because partial sections of the gliding surface may be made with differing degrees of compaction and proportions of pores depending on the initial thickness chosen and the subsequent compaction of the base structure. For example, in the region of the longitudinal side edges, the base structure may have a higher proportion of plastic material and at the same time, there may be a higher proportion of pores in the middle region, thereby incorporating more additives.

Using the method based on the characterizing features defined in claim 4, every predefined individual partial section of the facing material may be adapted for a different ultimate purpose. For example, a more resistant plastic material may be used in the region of the longitudinal side edges, whereas a different, softer base material may be used in the central or middle region for example. This results in an ability to withstand extreme stress at the edges on the one hand and improved gliding properties when the winter sports device is on the ground on the other hand.

Another advantageous approach is described in claim 5, whereby depending on the proportion of pores by volume, the strength of the facing material and the quantity of additives available can be adapted to suit the most varied range of usage conditions, and a sufficient quantity of additives can still be incorporated in the facing material even if there is only a low proportion of pores.

Another approach based on the characterizing features defined in claim 6 is of advantage because the facing material can be manufactured for an exactly pre-definable, individual intended purpose. For example, with a lower proportion of pores with the associated higher proportion of plastic in the base structure, a more solid and stable facing material can be produced, whereas with a higher proportion of pores, the quantity of additives incorporated can be increased. This enables the gliding or climbing properties of the winter sports devices to be improved for example.

Also of advantage is a variant of the method defined in claim 7, because additives can be incorporated across the entire thickness or depth of the facing material. As a result, a sufficient quantity of additives is always provided across the entire thickness or depth, in addition to which it is always possible for additives to be transported out of the pores in the facing material during gliding.

As a result of the approached based on the characterizing features defined in claim 8, an open-pored base structure for incorporating additives can be produced without the need for subsequent finishing processes and the inclusion process is therefore simple and cost-effective.

Another advantageous approach is defined in claim 9 because it enables the quantity of incorporated additives to be easily set on the one hand and the degree of deformation of the base structure can be predetermined on the other hand.

An approach based on the characterizing features defined in claim 10 is also of advantage because it in turn enables the facing material to be adapted exactly as a function of its intended purpose.

A variant of the method defined in claim 11 is of advantage because in this instance, the base structure constitutes the predominant part of the surface of the gliding surface but additives can still be included in the base structure to improve gliding properties.

The advantage of an approach based on the characterizing features defined in claim 12 is that it offers the possibility of greater variation in terms of the visual appearance of transparent or opaque facing structures. It also improves and facilitates the joining process to the base construction of the gliding device.

Another advantageous approach is defined in claim 13, whereby a saving can be made on the cost of the printing operation because it is much easier to apply a printed image to the adhesive layer than to the rear face of the base structure.

The variant of the method defined in claim 14 is also of advantage because it enables allowance to be made for a whole range of different applications and enables bonding to the base construction of the gliding device to take place at the same time.

Due to the characterizing features defined in claim 15, a visual block can be achieved if using transparent or opaque facing materials. It also permits and improves bonding to the base construction of the gliding device.

Also of advantage is a variant o the method defined in claim 16, because the facing material can be adapted to suit a range of different conditions of usage, thereby enabling the gliding properties to be improved.

An approach based on the characterizing features defined in claims 17 or 18 is also of advantage because it enables facing materials to be produced free of tension since the base structure is not subjected to tensile stress during compaction. There is also no further stretching of the facing material during the subsequent production steps, thereby enabling significantly more transparent or opaque facings to be produced for winter sports devices. Furthermore, no undesired deformation or distortion occurs during storage of the semi-finished product, which might otherwise lead to unevenness. The subsequent process of bonding to the base construction of the gliding device is made much easier as a result and wastage is avoided.

A variant of the method defined in claim 19 is also of advantage because, depending on the winter sports device to be produced, a cutting of the facing material can be produced to match it, thereby ensuring cost-effective and problem-free bonding during the subsequent bonding process.

An approach based on the characterizing features defined in claim 20 is also of advantage because semi-finished products pre-filled with additives can be produced, which can then be bonded to the gliding device to form the winter sports device in a single work step. Due to the fact that heat is not applied to the semi-finished product except during the bonding process, no distortion occurs later during storage, which means that planar and flat components are always available for bonding to the gliding device.

Also of advantage is a variant of the method defined in claim 21, because the process of bonding to the gliding device can be operated at a lower pressure and/or a lower temperature than has been standard practice with sintered facings or sintering processes used to date because the hot pressing operation has already been run prior to bonding with the gliding device. The facing material can also be prefabricated to a certain degree and allowance can be made more rapidly for different gliding properties of the winter sports device depending on the additives incorporated in it. However, it is also possible to store a supply of semi-finished products, thereby enabling a rapid reaction to different customer requirements.

An approach based on the characterizing features defined in claim 22 is also of advantage because an optimum pressing process for the materials can be run, depending on the plastics selected for the base structure and the additives incorporated in them. However, it also avoids any thermal stress to the base structure.

Another advantageous approach is defined in claim 23, which not only enables the porous sections to be formed in the gliding surface but also permits shaping to suit different intended uses of the winter sports devices. The different shapes of the indentations can also be used to accommodate lubricants and also to produce a positive support on the surface of the gliding surface directed towards the ground.

Finally, a variant of the method defined in claim 24 is also of advantage because a base quantity or base substance of additives can be incorporated in the pores of the base structure prior to the hot pressing operation, which can be easily adapted to special applications at a later stage.

The objective of the invention is also independently achieved on the basis of the features defined in claim 25. The advantages obtained as a result of this combination of features reside in the fact that at least one additive can be incorporated in the continuous open-pored plastic material of the base structure prior to the hot pressing operation already, when the pores are still of a relatively large volume, thereby enabling a higher quantity of additives to be included inside the base structure. Since the base structure with the pores formed in it is made first of all and the additive is not incorporated until the hot pressing operation, a significantly higher number of additives is available for use. Accordingly, the additives are incorporated in the base structure separately from the process of producing the base structure and the additives can not have any detrimental effect on the process of producing the base structure. Since the additives are incorporated in the pores of the base structure at a later stage, it is also possible to use additives which would otherwise tend to separate during the process of manufacturing the base structure or would not even be suitable for this purpose at all because they would be “sucked into” the semi-finished product during the processing step of filling the pores. This also makes it possible to incorporate significantly higher concentrations of additives in the pores of the base structure than has been the case with the methods used to produce facing materials in the past. The process of incorporating the additives in the pores of the base structure will then depend on the respective aggregate state of the additive, and the volume of the individual pores is of a sufficient size to accommodate a high quantity of additives prior to the hot pressing operation. During the subsequent hot pressing operation after the additives have been incorporated in the pores, a highly compacted gliding surface is obtained in which the lubricant is incorporated in the entire facing material in what might be regarded as supply chambers. This also makes both processing and storage easier because a standard base structure can be produced from the open-pored plastic material and it is not until the winter sports devices are actually manufactured that the additive or additives is or are incorporated in the pores. Due to the hot pressing operation, a semi-finished product can be obtained which can then be forwarded for additional processing to produce the winter sports device.

Also of advantage is another embodiment defined in claim 26, because the base structure forms the predominant proportion of the surface of the gliding surface but the additives are still distributed inside the base structure, which improves the gliding properties.

Also of advantage is an embodiment defined in claim 27 because additives are incorporated across the entire thickness or depth of the facing material. This being the case, a sufficient quantity of additives is always available across the entire thickness or depth, in addition to which additives can be transported out of the pores in the facing material during gliding.

An embodiment based on the characterizing features defined in claim 28 is also of advantage because the facing material can be produced on an exactly pre-definable basis to suit the individual intended purpose. For example, a smaller proportion of pores and the increased proportion of plastic in the base structure obtained as a result will make for a stronger and more stable facing material, whereas a higher proportion of pores can be used to increase the quantity of additives incorporated. This enables the gliding or climbing properties of the winter sports device to be improved, for example.

As a result of the embodiment based on the characterizing features defined in claim 29, every predefined individual partial section of the facing material can be adapted to different intended purposes. For example, in the region of the longitudinal side edges, a more resistant plastic material may be used, whereas a different and, for example, softer base material may be used in the central or middle region. This will enable extreme stress at the edges to be absorbed on the one hand and will result in improved gliding properties on the other hand when the winter sports device is lying flat on the ground.

Another embodiment is possible based on the characterizing features defined in claim 30, whereby an open-pored base structure for incorporating additives is obtained without the need for subsequent finishing work and the process of incorporating them can be run easily and inexpensively.

Another advantageous embodiment is defined in claim 31 because it offers a simple way of enabling the quantity of additives to be fixed on the one hand and enables the degree of deformation of the base structure to be predefined on the other hand.

Another possible embodiment is based on the characterizing features defined in claim 32 and it in turn enables the facing material to be exactly adapted to suit its intended purpose.

Another embodiment based on the characterizing features defined in claim 33 is of advantage because it offers more possible variations when using transparent or opaque facing structures in terms of the visual design. It also enables the process of bonding to the base construction of the gliding device to be improved and made easier.

Another advantageous embodiment is defined in claim 34, which enables a saving on the cost of the printing process because it is much easier to apply a printed image to the rear face of the base structure.

Also of advantage is another embodiment defined in claim 35 because it offers an easy way of making allowance for a range of different applications and simultaneously enables bonding of the base construction of the gliding device.

As a result of the embodiment based on the characterizing features defined in claim 36, a visual block is obtained if using transparent or opaque facing materials. Furthermore, bonding to the base construction of the gliding device can be improved.

Also of advantage is another embodiment defined in claim 37 because the facing material can be easily adapted to different conditions of usage, thereby enabling the gliding properties to be improved.

Also of advantage is an embodiment defined in claim 38 because a base quantity or base substances of additives can be incorporated in the pores of the base structure prior to the hot pressing operation, which can be easily adapted for special applications at a later stage.

Another advantageous embodiment is defined in claim 39, which not only enables the pore portions to form the gliding surface but also permits shaping to suit different purposes of the winter sports devices. The different shapes of the indentations may additionally be used to accommodate lubricants and also to provide a positive support on the ground surface directed towards the gliding surface.

Finally, the objective of the invention is also independently achieved on the basis of the characterizing features defined in claim 40. The advantages obtained as a result of the combination of features defined in the characterizing part of this claim reside in the fact that a winter sports device with a range of different gliding properties can be produced depending on the additives incorporated in the facing material.

### BRIEF DESCRIPTION OF THE DRAWINGS

To provide a clearer understanding, the invention will be explained in more detail below with reference to the appended drawings. These provide highly simplified, schematic diagrams as follows:

FIG. 1 shows a winter sports device with a facing material proposed by the invention constituting the gliding surface;

FIG. 2 is a highly simplified diagram showing a view in section of the facing material in its unformed initial state;

FIG. 3 shows the facing material illustrated in FIG. 2 with an additive incorporated in the pores;

FIG. 4 shows the facing material illustrated in FIGS. 2 and 3 with its reduced useful thickness after the hot pressing operation;

FIG. 5 illustrates the facing material with additional layers still before the operation of joining to the gliding device, with the individual layers disposed at a distance apart from one another;

FIG. 6 is a simplified, schematic diagram showing a plan view of the facing material with different partial sections;

FIG. 7 is a highly simplified diagram showing a view in section of another possible cross-section of the facing material prior to the hot pressing operation and without a detailed illustration of the base structure incorporating the pores.

### DETAILED DESCRIPTION OF PREFERRED EMBODIMENTS

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

All the figures relating to ranges of values in the description should be construed as meaning that they include any and all part-ranges, in which case, for example, the range of 1 to 10 should be understood as including all part-ranges starting from the lower limit of 1 to the upper limit of 10, i.e. all part-ranges starting with a lower limit of 1 or more and ending with an upper limit of 10 or less, e.g. 1 to 1.7, or 3.2 to 8.1 or 5.5 to 10.

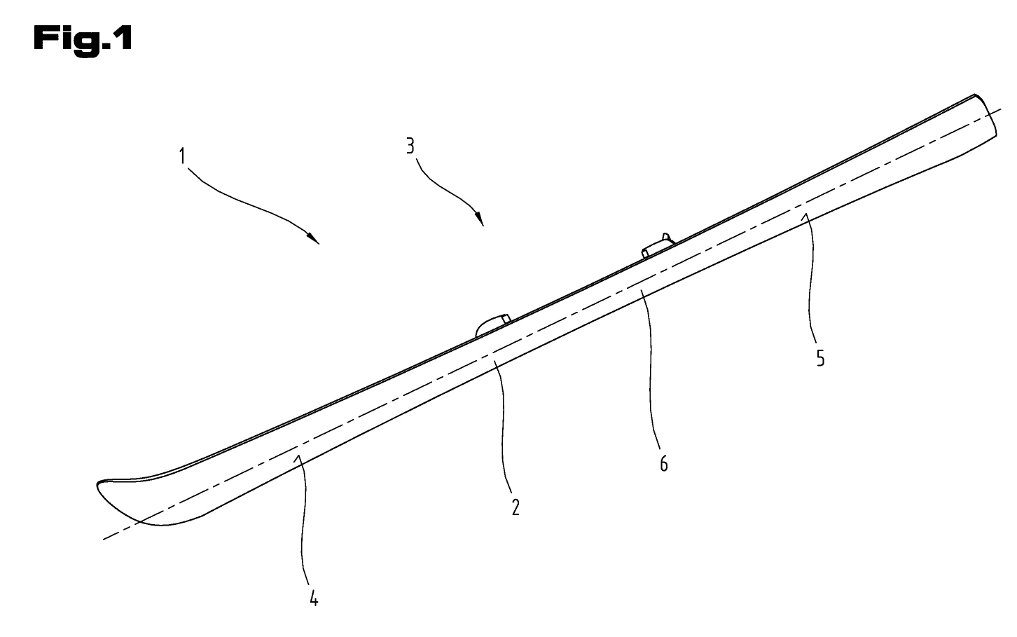

FIG. 1 provides a schematic illustration of a winter sports device 1 with a board-type gliding device 2 and a coupling mechanism 3 for connecting to a user's shoe, although this is not illustrated. The winter sports device 1 or gliding device 2 might be a ski, snowboard, long-distance ski, short ski, snow glider or similar.

The winter sports device 1 or gliding device 2 has a running sole 4, which forms a gliding surface 5 on the side remote from the coupling mechanism 3. The purpose of the running sole 4 is to glide in a gliding movement by means of its gliding surface 5 on snow and/or ice on the ground surface. Due to the interaction which occurs during gliding between roughness peaks of the running sole 4 with its gliding surface 5 and the snow or ice crystals, the heat locally generated by friction causes the snow or ice crystals to melt. The melt water created in situ then leads to hydrodynamic lubricating conditions, enabling a low coefficient of sliding friction to be obtained. Particularly at high speeds such as occur during alpine racing sports, the parameters which result in undisrupted gliding in a dynamic flow are vital. The supply, processing and subsequent finishing of the running sole 4 are also of particular importance.

The running sole 4 of the winter sports device 1 is formed by a facing material 6 applied to the gliding device 2, which will be described in detail below with reference to the drawings.

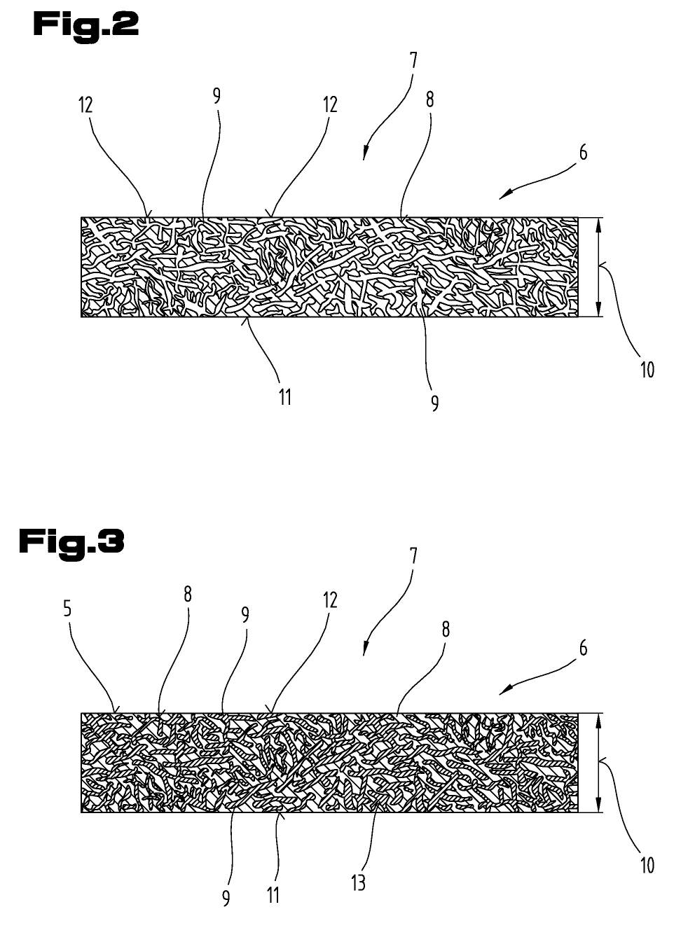

FIGS. 2 to 4 provide simplified, schematic illustrations of the facing material 6 used to form the running sole 4 of the winter sports device 1 in different states during the manufacturing process.

FIG. 2 shows a base structure 7 made from a preferably continuous, open-pored plastic material 8. The base structure 7 therefore comprises the plastic material 8 and a plurality of cohesive pores 9, which together form an approximately sponge-type pattern. The plastic 8 of the base structure 7 thus forms a sort of support structure with a net-type or lattice pattern, between which the individual pores 9 are formed or disposed.

The plastic 8 used to make the base structure 7 may be a polymer material for example, which is produced in a continuous sintering process. Accordingly, plastic powder with a specific grain size can be applied to a conveyor belt in a layer, preferably with a predefined constant thickness and width. The plastic powder can then be pre-compacted and warmed or heated until the sintering process is induced, during which the pores 9 form in the flat, in particular web-shaped, base structure 7. Alternatively, however, the porous base structure 7 could be produced by a foaming process or similar production techniques. The materials used may be selected from the group comprising polyethylene with an ultra-high molecular weight (UHMWPE), polyvinylidene fluoride (PVDF), polypropylene (PP).

The base structure 7 incorporates the gliding surface 5 facing the ground in the region of the running surface. In an initial thickness 10 starting from the gliding surface 5, the base structure 7 is bounded by a rear face 11 on the side facing away from it. The base structure 7 for forming the facing material 6 is a flat, in particular web-shaped body, and the initial thickness 10 is selected with a lower limit of 0.5 mm, in particular 2.0 mm, and a lower limit of 8.0 mm, in particular 5.0 mm.

In its unformed initial thickness 10, the base structure 7 constitutes a proportion within a lower limit of 20%, preferably 40%, and an upper limit of 90%, preferably 60%. The proportion of pores may also preferably represent 50%. The figures relating to the proportion of pores are based on the total volume of the base structure 7. As may be seen from the simplified diagram of the pores 9, they form a cohesive capillary structure inside the base structure 7. Air, for example, is therefore able to pass through the entire initial thickness 10 through to the rear face 11 when the gliding surface 5 is in the unformed initial position.

As also illustrated on a simplified basis, not only the plastic material 8 but also the pores 9 of the base structure 7 form a surface portion 12 of the gliding surface 5 in the un-formed initial thickness 10. The gliding surface 5 is therefore formed by both the plastic 8 and the pores 9 disposed in and between it.

FIG. 3 shows the base structure 7 illustrated in FIG. 2 but at least one additive 13 is disposed in or has been introduced into the pores 9 of the base structure 7. In this respect, the proportion of additive 13 by reference to the pores 9 in the base structure 7 as a proportion of volume in the still unformed initial thickness 10 may lie within a lower limit of 50% and an upper limit of 100%.

The additive 13 may be selected from the group comprising liquid or solid substances, suspensions or substances which change their aggregate state. The liquid substances include oils, solutions, etc., for example. The solid substances may be chosen from a range of different materials of any grain size, such as powders, particulate substances, nano-particles, graphite, polytetrafluoroethylene or quartz. The suspensions include pastes or gels, for example. The substances which are capable of changing their aggregate state under the effect of temperature include various waxes. By introducing additives 13 after producing the base structure 7, a number of different additives 13 can therefore be incorporated in the pores 9, which has not been possible in the past or has been so only under certain conditions by mixing in the plastic material 8 prior to producing the base structure 7. The base structure 7 as such is produced first of all and it is only then that the additives 13 are incorporated in the pores 9 prior to the hot pressing operation.

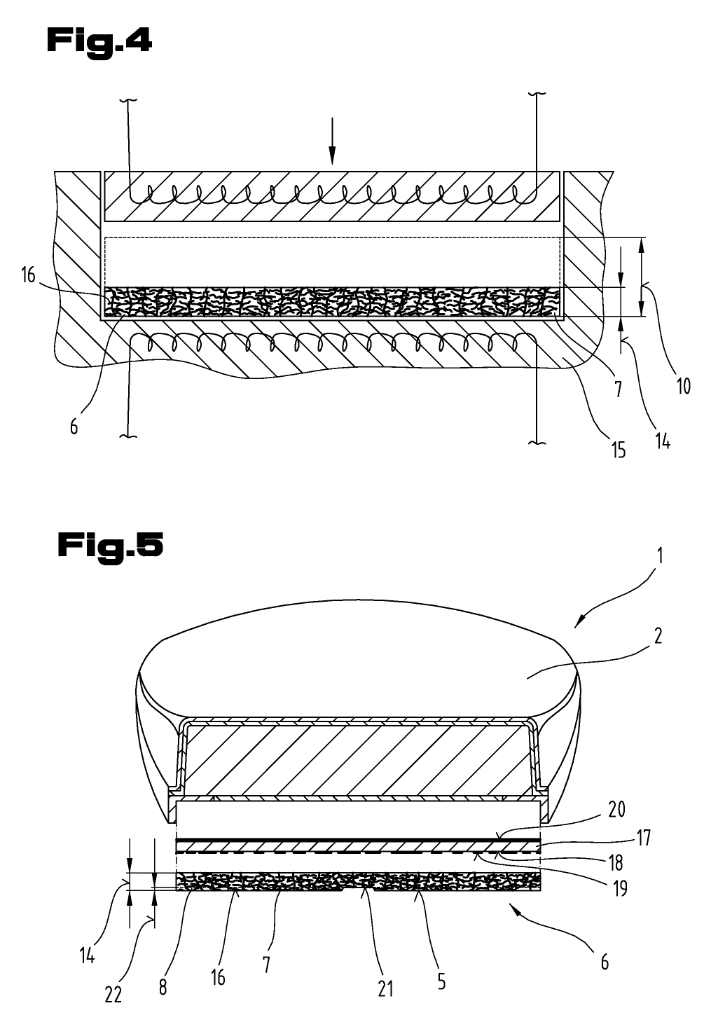

FIG. 4 shows the base structure 7 illustrated in FIG. 3 after it has been subjected to a compaction process, starting from the initial thickness 10 through to a useful thickness 14. A pressing die 15 is also illustrated on a simplified basis.

The base structure 7 together with the additive 13 is therefore reduced from its initial thickness 10 by an amount within a lower limit of 20% and an upper limit of 90% in a hot pressing operation. It may also be preferable to select the amount so that it is between 40% and 60%, in particular 50%. Only the thickness of the base structure 7 incorporating the additive or additives 13 is reduced. The hot pressing operation is conducted in a temperature range with a lower limit of 20° C., in particular 80° C., and an upper limit of 250° C., in particular 175° C. By hot pressing operation is meant every pressing operation during which heat is applied to the base structure 7 of the plastic 8 and additive 13 in addition to force. This may involve the use of heating devices of various types or other electromagnetic or optical radiation.

The pressing force (F) needed for the hot pressing operation is statically applied to the base structure 7 and preferably exclusively in the vertical direction by reference to the gliding surface 5.

As also illustrated on a simplified basis, the pores 9 of the base structure 7 are re-shaped by the hot pressing operation from their non-formed initial size to micro-pores 16 with a size within a lower limit of 1 μm, in particular 2 μm, and an upper limit of 500 μm, in particular 50 μm, thus being reduced in size in particular. These figures relate to the surface by reference to the cross-sectional dimensions of the pores 9. Since the additive 13 is introduced into the as yet unformed pores 9 prior to the hot pressing operation, the additive 13 is distributed in a uniform proportion across all the micro-pores 16 and hence across the entire volume of the compacted base structure 7. Since the pores 9 already form a cohesive capillary structure prior to hot pressing and compaction, the micro-pores 16 also form such a cohesive capillary pattern in the base structure 7. Due to the open-pored arrangement described above, both the plastic material 8 of the facing material 6 and the micro-pores 16 form the common gliding surface 5 in the compacted useful thickness 14 of the base structure 7. The predominant flat proportion is made up of the plastic 8 of the base structure 7, however. This results in a virtually smooth, compact gliding surface 5 because the micro-pores 16 constitute the most minimal surface portion of the total gliding surface 5.

The micro-pores 16 serve as supply chambers inside the base structure 7, ensuring that a sufficient quantity of additive 13 is present in the base structure 7 during gliding. If the additive 13 is removed or escapes from the micro-pores 16 during gliding, it can be introduced back into the micro-pores again subsequently during a separate servicing operation. It might be different types of lubricants, such as waxes or similar.

After compaction, the micro-pores 16 of the base structure 7 are filled with a proportion of additive 13 based on a lower limit of 50% and an upper limit of 100%. The figures relating to the degree of filling of the micro-pores 16 again relate to the proportion by volume.

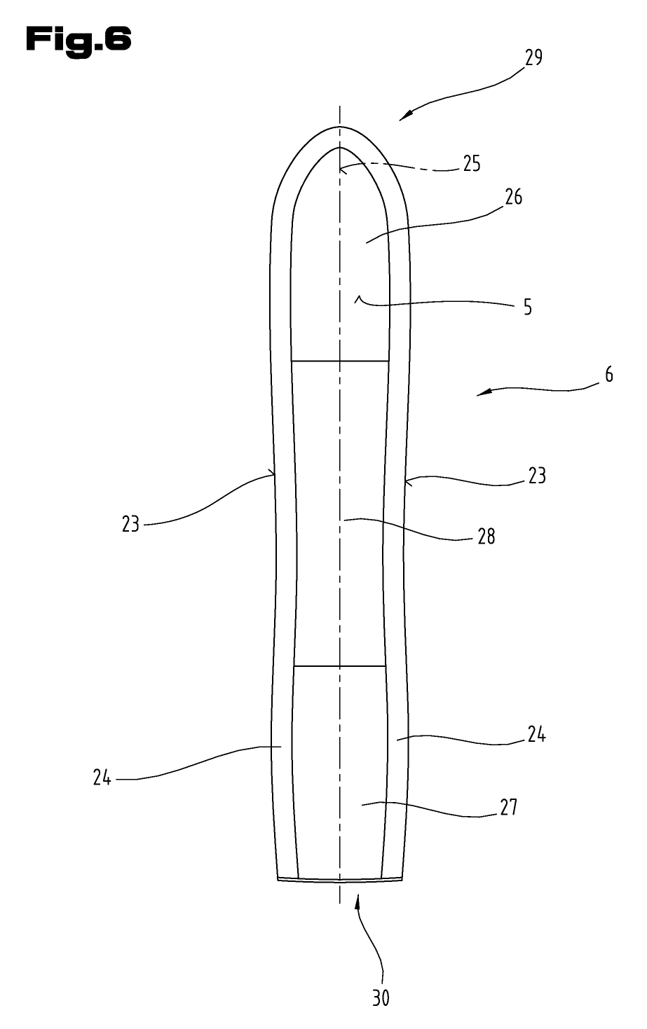

FIG. 5 provides a simplified, schematic illustration of the facing material 6 with its gliding surface 5 before the process during which it is joined to the gliding device 2 to form the winter sports device 1, with the individual layers in a position separated from one another. The base structure 7 made from the plastic material 8 has already been reduced to its useful thickness 14 and for the sake of improving clarity is illustrated at a distance apart from the remaining structure of the gliding device 2.

In order to join the base structure 7 to the remaining structure of the winter sports device 1, it is of advantage if an adhesive layer 17 is applied to, in particular formed on, the base structure 7 on the side facing away from the gliding surface 5. Joining may take place in a variety of ways. The adhesive layer 17 may be selected from the group comprising woven fabrics, knitted fabrics, non-woven materials, hardboard, Al compounds, plastic film compounds, etc.. Depending on the choice of adhesive layer 17, it may already cause a bonding or adhering operation if it is formed by a heat-curable adhesive layer but it is also possible to apply a coating of the latter. In the case of naturally smooth substances, the surfaces to be joined should be pre-treated to improve adhesion. This might involve the application of primers, varnish coatings or incisions or similar.

The plastic material 8 and the additives 13 introduced into or incorporated in it may either by see-through to transparent or fully opaque. This will depend on the coloring of the plastic materials 8 or the coloring of the incorporated additives 13. If a transparent or see-through plastic material 8 is used for the base structure 7 and a likewise see-through or transparent additive 13 is used, a printed image 19 can be applied to a surface 18 of the adhesive layer 17 facing the base structure 7 before the process of joining to the base structure 7. The printed image 19 is indicated by thick broken lines of different lengths. Depending on the choice of printed image 19 and the adhesive layer 17, it may also be of advantage to apply an additional background coat 20 to the adhesive layer 17 on the side facing away from the gliding surface. The purpose of this background coat 20 is to prevent the base construction of the gliding device 2 being seen through the plastic material 8 if it is transparent or see-through. The background coat 20 might be a varnish, an opaque polymer coating or similar, for example. The background coat 20 may also be described as a decorative or contrasting coating. It is used on the one hand to provide a visual block to a certain degree and on the other hand may also serve as a bonding or adhesive layer if the material is chosen accordingly.

As illustrated on a simplified basis, the facing material 6 is adapted and cut to the appropriate external contour before it is joined to the winter sports device 1 to be produced. How it is adapted or cut will depend on what winter sports device 1 is being made. In the case of the winter sports device 1 illustrated in FIG. 5, it is a ski or a snowboard with a side edge attached to it made from iron or steel. The facing material 6 is therefore cut to an external contour which will fit the fitting space intended for it so that it can then be joined to form the winter sports device 1. The joining process, which usually involves applying pressure and/or heat, improves compensation for manufacturing tolerances in the cutting because the facing material 6 is slightly deformed and can therefore be more readily adapted to the contour of the fitting space of the gliding device 2. This enables a seamless transition to be obtained between the side edge and facing material 6 after cooling.

If producing a long-distance ski, for example, which does not usually have steel edges, the facing material 6 is cut so that it is appropriately over-sized, for example with parallel strips, and then joined to the base construction of the gliding device 2 for the winter sports device 1. This is followed by the requisite finishing operation on the facing material 6 which involves trimming along the contour of the gliding device 2. The disposition of the layers described above may be the same in this instance.

The hot pressing operation described above may take place either during the process of joining to the winter sports device 1 or before joining to the winter sports device 1. This may be freely chosen depending on the manufacturing process used to make the winter sports device 1.

Furthermore, during the hot pressing operation, it is also possible to form an indentation 21 in the gliding surface 5 of the facing material 6. Such an indentation 21 is indicated on a simplified basis in FIG. 5 as a longitudinal groove. However, the indentation 21 may also be provided in the form of a scale, a fish scale pattern, a ground structure or a microstructure. These scales or this scale pattern serves as a climbing aid on long-distance skis.

If the facing material 6 is hot pressed before being joined to the gliding device 2 and its initial thickness 10 is reduced to the useful thickness 14, at least one of the additives 13 can also be introduced into and incorporated in the micro-pores 16 as a surface coating 22 of the facing material 6, thereby increasing the concentration. This offers an even greater variety of options in terms of the additives 13 which can be incorporated in the micro-pores 16.

FIG. 6 provides a simplified illustration of the facing material 6 with its gliding surface 5 as a prefabricated unit prior to the process of joining it to the gliding device 2. To avoid unnecessary repetition, reference may be made to the detailed description given in connection with FIGS. 1 to 5 above. The same component names and the same reference numbers are used to denote components that are the same as those described with reference to FIGS. 1 to 5 above.

In the region of its external contour, the facing material 6 has a cut, which already matches the winter sports device 1 to be produced. The facing material 6 has longitudinal edges 23 spaced at a distance apart from one another as viewed transversely to their longitudinal extension. These longitudinal edges 23 come into contact with a so-called steel edge in the case of certain winter sports devices 1 and the steel edge forms the external boundary region of the winter sports device 1.

In the region of the gliding surface 5, various partial sections of the gliding surface 5 are illustrated separately by thin dashes spaced apart from one another. For example, the gliding surface 5 may have a peripheral portion 24 adjacent to the longitudinal edges 23 and a front and rear middle portion 26, 27 spaced apart from one another in the region of a longitudinal axis 25. A central portion 28 may also be provided between the front and rear middle portions 26, 27. The longitudinal axis 25 extends from a tip 29 to an end 30 of the facing material 6.

These schematically illustrated portions 24 and 26 to 28 have been chosen as an example but they may be disposed in any arrangement on the gliding surface 5. The only essential aspect is that the facing material 6 is always designed as an integral component.

The layout and appearance of the different portions 24 to 28 permit a very large variety of combinations and options for the design of the base structure 7 made from the plastic material 8, the pores 9 disposed in the plastic material 8, the proportion of pores and the additives 13 incorporated in the pores 9.

For example, the base structure 7 may have a gliding surface 5 made from a different plastic material 8 in the individual portions 24 and 26 to 28. Irrespective of this, however, the proportion of pores in the base structure 7 may differ in different portions of the gliding surface 5. Furthermore, additives 13 may be incorporated in the individual pores 9 of the base structure 7 which differ in different portions of the gliding surface 5. For example, sand or quartz grains might be incorporated in the central portion 28, in which case the facing material 6 incorporating these will serve as a climbing aid in the case of long-distance skis. This will result in greater friction between the central portion 28 of the facing material 6 and the ground surface, not illustrated, when subjected to pressure. When the pressure is released, on the other hand, the facing material 6 may incorporate additives 13 in the region of the front and rear middle portions 26, 27 which in turn impart good gliding properties.

If differing additives 13 are incorporated in different portions in the individual pores 9 of the base structure 7, this may be done on the basis of a selectively pre-programmed application to the gliding surface 5. The process of applying the additives 13 could be likened to inkjet printing process. Accordingly, each of the different additives 13 could be applied to exactly pre-definable portions 24 and 26 to 28 on the gliding surface 5 and incorporated in the pores 9. Since the pores 9 or compacted micro-pores 16 jointly form a surface portion 12 with the plastic material 8 of the base structure 7, it could be said that the surface portion 12 is of a microscopic design. In the described portions 24, 26 to 28, on the other hand, the design of the surface portions could be described as macroscopic.

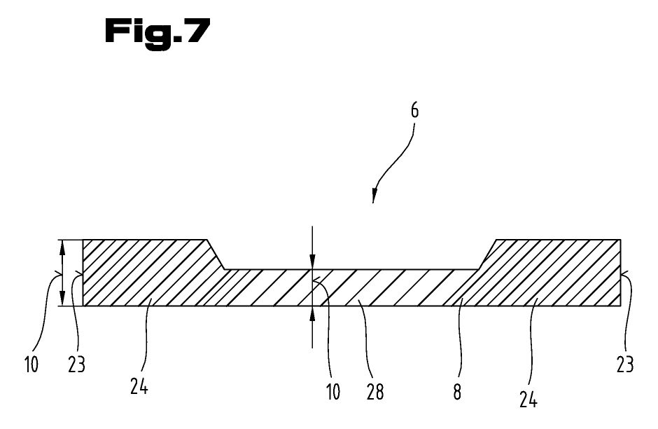

FIG. 7 shows a cross-section through the facing material 6 prior to forming and incorporating the additives 13. For the sake of simplicity, the individual pores 9 and the base structure 7 have been omitted from the drawing and are merely indicated by hatching. To avoid unnecessary repetition, reference may be made to the detailed description of FIGS. 1 to 6 above. Again, the same component names and reference numbers are used to denote components that are the same as those described in connection with FIGS. 1 to 6 above.

As viewed in cross-section, the base structure 7 has some portions in which the gliding surface 5 is of a differing initial thickness 10. In the embodiment illustrated as an example here, the initial thickness 10 in the region of the longitudinal edges 23 is bigger than in the region of the longitudinal axis 25. This means that there is a higher proportion of plastic material 8 by volume in the peripheral portions 24, and a higher compaction factor can be achieved than in the middle or central portions 26, 27, 28 for the same proportion of pores, for example.

In order to obtain a high operating strength of the facing material 6 precisely in the region of the longitudinal edges 23, it is possible to incorporate additives 13 in the peripheral portions 24 which impart resistance to the effect of temperature and high pressure and frictional forces. However, it would likewise be possible to select a high-strength plastic 8 as the material used to make the peripheral portions 24. The only essential aspect is that the facing material 6 is of an integral design, even if it is made from different plastic materials 8 in the individual portions 24, 26 to 28.

As a result of the variety of different options for the facing material 6 described above with the additives 13 incorporated in it, processing, finishing and polishing, etc., can be significantly improved and simplified.

The embodiments illustrated as examples represent possible variants of the facing material 6, and it should be pointed out at this stage that the invention is not specifically limited to the variants specifically illustrated, and instead the individual variants may be used in different combinations with one another and these possible variations lie within the reach of the person skilled in this technical field given the disclosed technical teaching. Accordingly, all conceivable variants which can be obtained by combining individual details of the variants described and illustrated are possible and fall within the scope of the invention.

For the sake of good order, finally, it should be pointed out that, in order to provide a clearer understanding of the structure of the facing material 6 and the winter sports device 1, they and their constituent parts are illustrated to a certain extent out of scale and/or on an enlarged scale and/or on a reduced scale.

The objective underlying the independent inventive solutions may be found in the description.

Above all, the individual embodiments of the subject matter illustrated in FIGS. 1; 2, 3, 4; 5; 6; 7 constitute independent solutions proposed by the invention in their own right. The objectives and associated solutions proposed by the invention may be found in the detailed descriptions of these drawings.

### LIST OF REFERENCE NUMBERS

1 Winter sports device
2 Gliding device
3 Coupling mechanism
4 Running sole
5 Gliding surface
6 Facing material
7 Base structure
8 Plastic material
9 Pore
10 Initial thickness
11 Rear face
12 Surface portion
13 Additive
14 Useful thickness
15 Pressing die
16 Micro-pore
17 Adhesive layer
18 Surface
19 Printed image
20 Background coat
21 Indentation
22 Surface coating
23 Longitudinal edge
24 Peripheral portion
25 Longitudinal axis
26 Front middle portion
27 Rear middle portion
28 Central portion
29 Tip
30 End

1. A method of producing a flat, in particular web-shaped, facing material with a gliding surface for a running sole of a winter sports device, whereby
a base structure made from a continuously open-pored plastic material with an initial thickness is produced;
at least one additive is introduced into the pores of the base structure;
the base structure together with the additive is reduced from its initial thickness by an amount within a lower limit of 20% and an upper limit of 90% in a hot pressing operation.

2. A method according to claim 1, wherein the initial thickness of the base structure is selected so as to be within a lower limit of 0.5 mm and an upper limit of 8.0 mm.

3. A method according to claim 1, wherein the initial thickness of the base structure is designed with a gliding surface with portions that are different from one another.

4. A method according to claim 1, wherein the base structure is designed with a gliding surface with portions that are made from a different plastic material.

5. A method according to claim 1, wherein the base structure is designed with a proportion of pores within a lower limit of 20% and an upper limit of 90% in its unformed initial thickness.

6. A method according to claim 1, wherein the proportion of pores in of the base structure differs in different portions of the gliding surface.

7. A method according to claim 1, wherein a cohesive capillary structure is formed in the base structure by the pores in it.

8. A method according to claim 1, wherein a surface portion of the gliding surface is formed by the pores of the base structure in the non-formed initial thickness.

9. A method according to claim 1, wherein the pores of the base structure in the as yet unformed initial thickness are filled with a proportion of additive within a lower limit of 50% and an upper limit of 100%.

10. A method according to claim 1, wherein the pores of the base structure are filled with different additives in different portions of the gliding surface.

11. A method according to claim 1, wherein the pores of the base structure are re-shaped, in particular reduced, from their unformed initial size to a size within a lower limit of 1 μm, in particular von 2 μm, and an upper limit of 500 μm, in particular von 50 μm, to form micro-pores by the hot pressing operation.

12. A method according to claim 1, wherein an adhesive layer is applied to the base structure on the side facing away from the gliding surface.

13. A method according to claim 12, wherein a printed image is applied to the adhesive layer on a surface facing the base structure before the process of joining to the base structure.

14. A method according to claim 12, wherein the adhesive layer is selected from the group comprising woven fabrics, knitted fabrics, non-woven materials, hardboard, Al compounds, plastic film compound.

15. A method according to claim 12, wherein a background coat, such as a varnish, an opaque polymer coating, is applied to the adhesive layer on the side facing away from the gliding surface.

16. A method according to claim 1, wherein the additive is selected from the group comprising liquid or solid substances, suspensions or substances which change their aggregate state, such as oils, solutions, powders of different grain sizes, particulate substances, nano-particles, graphite, polytetrafluoroethylene, quartz, pastes, gels or waxes.

17. A method according to claim 1, wherein the pressing force is applied statically during the hot pressing operation.

18. A method according to claim 1, wherein the pressing force is applied exclusively in the direction perpendicular to the gliding surface during the hot pressing operation.

19. A method according to claim 1, wherein the facing material to the winter sports device to be produced, it is adapted and cut so that its external contour matches the winter sports device to be produced.

20. A method according to claim 1, wherein the hot pressing operation is run during the process of joining to the winter sports device.

21. A method according to claim 1, wherein the hot pressing operation is run prior to joining to the winter sports device.

22. A method according to claim 1, wherein the hot pressing operation is run in a temperature range with a lower limit of 20° C., in particular 80° C., and an upper limit of 250° C., in particular 175° C.

23. A method according to claim 1, wherein an indentation, such as a groove, scale, a fish scale pattern, a ground structure, a microstructure, are formed in the gliding surface of the facing material during the hot pressing operation.

24. A method according to claim 11, wherein at least one of the additives is additionally introduced into the micro-pores of a surface coating of the facing material after the hot pressing operation, increasing its concentration.

25. A facing material with a gliding surface for a running sole of a winter sports device, comprising a base structure made from an open-pored plastic material and at least one additive disposed in the pores of the base structure, characterized in that the pores of the base structure are formed by micro-pores and the additive is distributed in a uniform proportion through all the micro-pores.

26. A facing material according to claim 25, wherein the micro-pores have a size with a lower limit of 1 μm and an upper limit of 500 μm.

27. A facing material according to claim 25, wherein the micro-pores form a cohesive capillary structure in the base structure.

28. A facing material according to claim 25, wherein the proportion of pores or the micro-pores in the base structure differs in different portions of the gliding surface.

29. A facing material according to claim 25, wherein the base structure is designed with a gliding surface with portions made from a different plastic material.

30. A facing material according to claim 25, wherein the base structure and the micro-pores jointly form the gliding surface.

31. A facing material according to claim 25, wherein the micro-pores of the base structure are filled with a proportion of additive with a lower limit of 50% and an upper limit of 100%.

32. A facing material according to claim 25, wherein the micro-pores of the base structure are filled with different additives in different portions of the gliding surface.

33. A facing material according to claim 25, characterized in that an adhesive layer is disposed on the base structure on the side facing away from the gliding surface.

34. A facing material according to claim 33, wherein a printed image is applied to the adhesive layer on the surface facing the base structure.

35. A facing material according to claim 33, wherein the adhesive layer is selected from the group comprising woven fabrics, knitted fabrics; non-woven materials, hardboard, Al compounds, plastic film compound.

36. A facing material according to claim 33, wherein a background coat, such as a varnish, an opaque polymer coating, is applied to the adhesive layer on the side facing away from the gliding surface.

37. A facing material according to claim 25, wherein the additive is selected from the group comprising liquid or solid substances, suspensions or substances which change their aggregate state, such as oils, solutions, powders of different grain sizes, particulate substances, nano-particles, graphite, polytetrafluoroethylene, sand grains or quartz, pastes, gels or waxes.

38. A facing material according to claim 25, wherein at least one of the additives is additionally introduced into the micro-pores of a surface coating of the facing material.

39. A facing material according to claim 25, wherein an indentation, such as a groove, scale, fish scale pattern, a ground structure, a microstructure, are formed in the gliding surface of the facing material.

40. A winter sports device with a running sole made from a facing material, wherein the facing material is as claimed in claim 25.
